(19) United States
(12) Patent Application Publication
(10) Pub. No.: US 2017/0015276 A1
(43) Pub. Date: Jan. 19, 2017

(54) Vehicle Anti-Theft System

(71) Applicant: Adel Ghadhban, Twin Falls, ID (US)

(72) Inventor: Adel Ghadhban, Twin Falls, ID (US)

(21) Appl. No.: 15/211,035

(22) Filed: Jul. 15, 2016

Related U.S. Application Data
(60) Provisional application No. 62/192,848, filed on Jul. 15, 2015.

(51) Int. Cl. B60R 25/01; B60R 25/104; B60R 25/24; B60R 25/042

(52) U.S. Cl. CPC B60R 25/01; B60R 25/042; B60R 25/104; B60R 25/24

(57) ABSTRACT

A vehicle anti-theft system for preventing an unauthorized person from stealing a user's vehicle. The vehicle anti-theft system includes a vehicle unit to be installed within a vehicle and a remote unit to be carried by the user. When a user is not utilizing the vehicle, the user can activate the vehicle unit which determines if the vehicle is moving. If the vehicle is moving while the vehicle unit is activated, the vehicle unit's alarm system will produce an audible alert, and the vehicle unit's deactivation unit will disable the vehicle to prevent the unauthorized person from further driving the vehicle. The remote unit is provided to activate and deactivate the vehicle unit and further can be used to remotely trigger the alarm system and the deactivation unit.

### CROSS REFERENCE TO RELATED APPLICATION

This application claims the benefit of U.S. Provisional Application No. 62/192,848 filed on Jul. 15, 2015. The above identified patent application is herein incorporated by reference in its entirety to provide continuity of disclosure.

### BACKGROUND OF THE INVENTION

### Field of the Invention

The present invention relates to vehicle security systems. More specifically, the present invention provides a vehicle security system comprising a vehicle unit adapted to be positioned within a vehicle configured to automatically or remotely shut off the vehicle engine in order to prevent the vehicle from being stolen.

Vehicle theft is a common occurrence that can be devastating to the vehicle owner. Once stolen, vehicles can be difficult or impossible to locate if the vehicle lacks any GPS locational or security features. Further, even if the vehicle is located, it can be looted or otherwise damaged. The vehicle owner may suffer a significant economic loss from having the vehicle stolen or damaged, and the vehicle owner may lack sufficient transportation until he or she can rent or purchase another vehicle. Thus, it is important to have proper security for a vehicle to prevent the vehicle from being stolen.

Devices in the known art have several known drawbacks. Many vehicles are equipped with various safety features such as locks and car alarms in order to prevent vehicle theft. However, if a person breaks into a vehicle and is able to start the vehicle using the keys or otherwise, it is difficult or impossible to stop the person from fleeing in the vehicle. Many vehicles lack means for deactivating the vehicle remotely. Further, if the person who steals the vehicle has the vehicle keys, the vehicle alarm and locks will not prevent the theft of the vehicle. Thus, an improved vehicle anti-theft system is desired.

In light of the devices disclosed in the prior art, it is submitted that the present invention substantially diverges in design elements from the prior art and consequently it is clear that there is a need in the art for an improvement to existing vehicle security devices. In this regard the instant invention substantially fulfills these needs.

### SUMMARY OF THE INVENTION

In view of the foregoing disadvantages inherent in the known types of vehicle security devices now present in the prior art, the present invention provides a new vehicle security device wherein the same can be utilized for providing convenience for the user when preventing a user's vehicle from being stolen.

The vehicle anti-theft device comprises a remote unit adapted to be carried by a user and a vehicle unit adapted to be installed within a vehicle. The vehicle unit comprises a microprocessor, a sensor, an alarm system, a deactivation unit, and a first wireless transceiver. The vehicle unit can be activated when the user is not in use of the vehicle. If the vehicle unit is activated, the sensor detects that the vehicle is in motion and signals the microprocessor that an unauthorized user is attempting to drive the vehicle. The alarm then activates an audible alert and the deactivation unit is adapted to prevent the vehicle from being driven. In one embodiment, the deactivation unit prevents the vehicle from being driven by shutting down the fuel pump that provides fuel to the engine of the vehicle.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic of the vehicle anti-theft device.

FIG. 2 shows a perspective view of one embodiment of the sensor of the vehicle anti-theft device.

### DETAILED DESCRIPTION OF THE INVENTION

Reference is made herein to the attached drawings. Like reference numerals are used throughout the drawings to depict like or similar elements of the vehicle security device. For the purposes of presenting a brief and clear description of the present invention, the preferred embodiment will be discussed as used for preventing a user's vehicle from being stolen. The figures are intended for representative purposes only and should not be considered to be limiting in any respect.

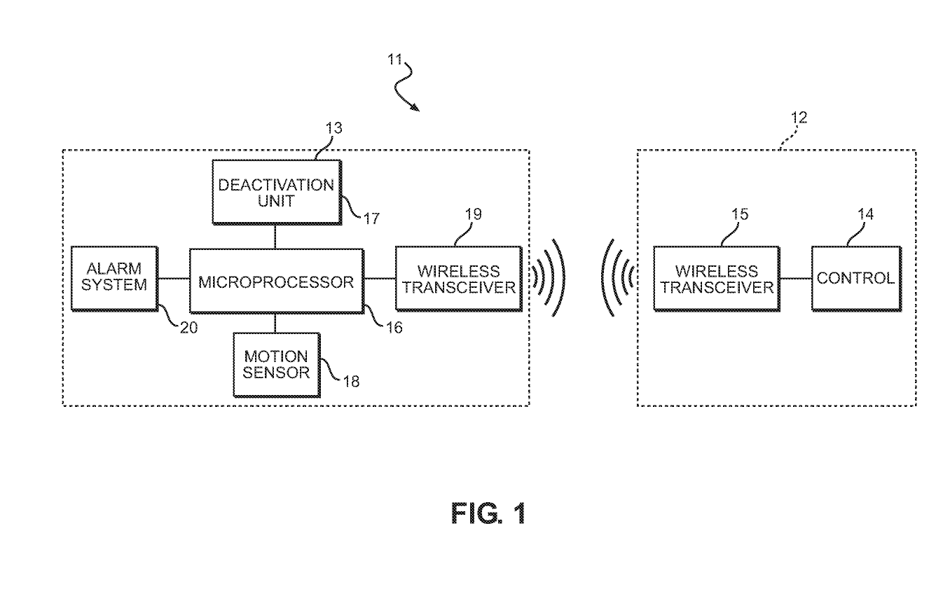

Referring now to FIG. 1, there is shown a schematic of the vehicle anti-theft device. The vehicle anti-theft device 11 comprises a remote unit 12 and a vehicle unit 13. The vehicle unit 13 is adapted to be installed within a vehicle, such as a car, truck, SUV, or the like. In one embodiment, the vehicle unit 13 is mounted to a dashboard of a vehicle. The vehicle unit 13 comprises a control circuit including a microprocessor 16, a deactivation unit 17, a sensor 18, a first wireless transceiver 19 and an alarm system 20.

The vehicle unit 13 can be selectively activated or deactivated via a switch. The vehicle unit 13 is adapted to be activated when the user it not utilizing the vehicle. When the vehicle unit is activated, the sensor 18 is used to determine if the vehicle is in motion. If the sensor 18 detects that the vehicle is in motion while the vehicle unit 13 is activated, this indicates that an unauthorized user is driving the vehicle. In one embodiment, the microprocessor 16 of the vehicle unit 13 comprises a timer that automatically activates the vehicle unit 13 during certain predetermined times, such as at night. The sensor 18 sends a signal to the microprocessor 16 which signals the alarm system 20 to produce an audible alert. The audible alert notifies the user and other individuals in the nearby area that the vehicle is being stolen. In one embodiments, the audible alert includes a horn assembly of a vehicle. Further, the audible alert serves to discourage the unauthorized user from stealing the vehicle. In another embodiment, the vehicle unit 13 includes one or more lights for indicating the activation or deactivation of the vehicle anti-theft device 11. The one or more lights may be disposed on the dashboard of the vehicle. For example, a yellow indicating light signals that the vehicle anti-theft device 11 is activated and a red indicating light signals that the vehicle anti-theft device 11 is deactivate.

Further, when the sensor 18 detects the vehicle is in motion, a signal is sent to the microprocessor 16 and to the deactivation unit 17. The deactivation unit 17 is operably connected to various vehicle systems in order to prevent the vehicle from continuing to be driven. This helps to prevent the thief from traveling with the vehicle. In the illustrated embodiment, the deactivation unit 17 is operably connected to the vehicle's engine so as to prevent the engine from functioning. In one embodiment, the deactivation unit 17 is configured to deactivate the engine by stopping fuel from entering the engine. For example, the deactivation unit prevents the vehicle from being driven by shutting down the fuel pump that provides fuel to the engine of the vehicle. In an alternative embodiment, the deactivation unit 17 causes electrical power to stop flowing to the engine. Thus, the deactivation unit 17 overrides the normal operation of the vehicle in order to cease the vehicle from further motion.

The remote unit 12 comprises a second wireless transceiver 15 and a control 14 that is adapted to be actuated in order to cause the second transceiver 15 to send a signal to the first transceiver 19 of the vehicle unit 13. In one embodiment, the remote unit 12 is a key fob operably connected to the vehicle unit 13. When the remote unit 12 is turned on or off via the control 14, the vehicle unit 13 is activated or deactivated, respectively. Further, the remote unit 12 can be used to sound the alarm system 20 and the deactivation unit 17. This allows the user to manually deactivate the vehicle and sound the alarm system 20.

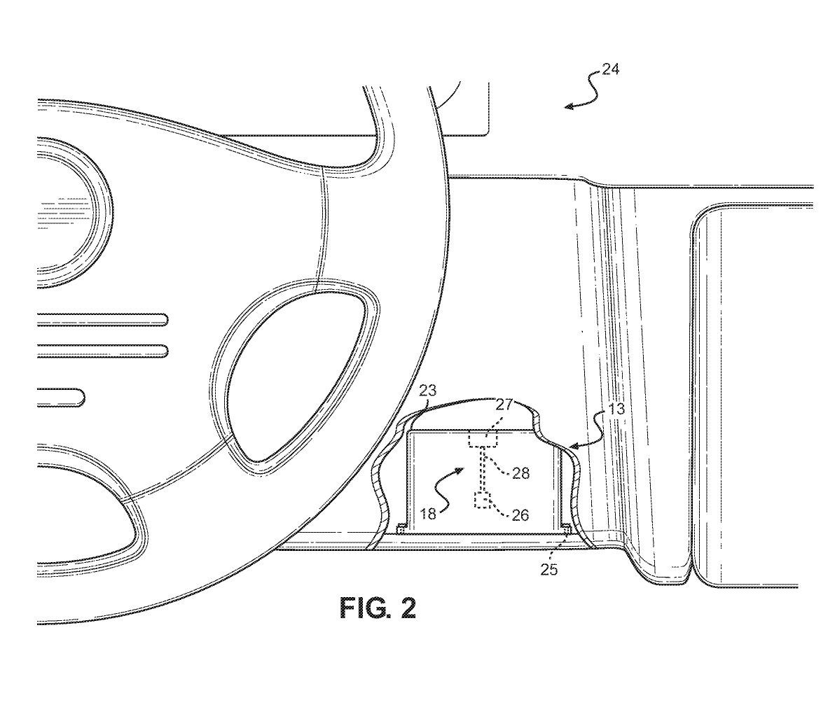

Referring now to FIG. 2, there is shown a perspective view of one embodiment of the sensor of the vehicle anti-theft device. The sensor 18 is configured to determine if a vehicle is in motion. In the shown embodiment, the vehicle unit 13 comprises a housing 23 mountable to a vehicle 24 via a fastener 25, wherein the sensor 18 comprises a pendulum sensor disposed therein. The sensor 18 includes a weighted bob 26 suspended and supported from a connection point 27 of the housing 23 via a rod 28. The pendulum sensor 18 is pivotally affixed to the connection point 27 and configured to assume a vertical plane relative to the housing 11. In this way, vehicle 24 motion causes relative movement between the pendulum sensor 18 and the housing 23. Upon detecting vehicle 24 motion, the sensor 18 sends a signal to the control circuit of FIG. 1.

In one example, an unauthorized user attempting to enter the vehicle 24 having the present system installed thereon, causes movement of the vehicle 24 detectable by the sensor 18. The movement may result from the breaking of a window, the opening of a door, or the sitting within the vehicle. The detection of vehicle 24 movement when the present system is activated causes the deactivation unit shut down the vehicle's engine so as to prevent the engine from functioning, activates an audible alarm, and activates an indicating light. In a preferred embodiment, the present system delays the deactivation of the engine for 30 seconds and the activation of the audible alarm and indicating light for 20 seconds.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle anti-theft system, comprising:
a vehicle unit, comprising:
a microprocessor;
a sensor configured to determine if a vehicle is in motion;
an alarm system adapted to produce an audible alert if the vehicle is in motion;
a vehicle deactivation unit adapted to deactivate the vehicle if the sensor determines that the vehicle is in motion;
a first wireless transceiver;
a remote unit, comprising a second wireless transceiver adapted to communicate with the first wireless transceiver of the vehicle unit, and one or more controls adapted to cause the second wireless transceiver to transmit a signal to the vehicle unit so as to control the alarm unit and the deactivation unit.

2) The vehicle anti-theft system of claim 1, wherein the vehicle deactivation unit is operably connected to a fuel pump of the vehicle.

3) The vehicle anti-theft system of claim 1, wherein the alarm system comprises a horn assembly of the vehicle.

4) The vehicle anti-theft system of claim 1, wherein the vehicle unit comprises a housing mountable to a vehicle via a fastener.

5) The vehicle anti-theft system of claim 1, wherein the sensor comprises a pendulum sensor configured to detect motion of the vehicle.

6) The vehicle anti-theft system of claim 5, wherein the pendulum sensor is supported from a housing, the pendulum sensor configured to assume a vertical plane relative to the housing.

7) The vehicle anti-theft system of claim 1, wherein the remote unit comprises a key fob.

8) The vehicle anti-theft system of claim 1, wherein the microprocessor comprises a timer that activates the vehicle unit at certain predetermined times.
